(19) United States
(12) Patent Application Publication
(10) Pub. No.: US 2007/0197178 A1
(43) Pub. Date: Aug. 23, 2007

(54) Automatic gain control system for receivers in wireless communications

(75) Inventor: Qizheng Gu, San Diego, CA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/359,745

(22) Filed: Feb. 21, 2006

(51) Int. Cl. H04B 1/06; H04B 7/00

(52) U.S. Cl. 455/232.1

(57) ABSTRACT

An AGC system in a receiver adjusts the front-end gain not only based on the received sector power level, but also based on the strength of the present interference. When there is no presence of strong electromagnetic interference, the front-end gain of the receiver is set at a high level so that the receiver is maintained at a high sensitivity level. The receiver is operable at a normal current mode and a current saving mode. The receiver is set to run at the normal mode when the received sector power is lower than a certain predetermined level or when a strong interference is present.

### FIELD OF THE INVENTION

The present invention relates generally to a receiver in a wireless communications system and, more particularly, to an automatic gain control circuit for use in the receiver.

### BACKGROUND OF THE INVENTION

An automatic gain control (AGC) circuit is commonly used in a receiver to adjust received signals to a desired reference level before the signals are further processed by the receiver. Conventionally, an RF receiver AGC system controls its front-end gain based on the received sector power level only. The front-end gain is switched at assigned sector power levels, which are derived based on the strength of possible interference sources. Usually, this is done without regard to the actual presence of those interference sources. As such, the receiver sensitivity is usually reduced after the front-end gain steps down. In order to achieve acceptable linearity, the receiver generally runs at a relatively high current mode.

### SUMMARY OF THE INVENTION

The AGC system, according to the present invention, adjusts the front-end gain not only based on the received sector power level, but also based on the strength of the present interference. When there is no presence of strong electromagnetic interference, the front-end gain of the receiver is set at a high level so that the receiver is maintained at a high sensitivity level or a lower receiver noise figure. When a strong electromagnetic interference is detected, the gain is reduced. Preferably, when a received sector power level (as measured by RSSI, for example) is lower than −82 dBm, for example in the CDMA mobile station case, the gain is set to high. If a strong interference, such as an interference stronger than −35 dBm, is detected, an interference level detector (IDL) flag is set to ON and the gain is reduced to a predetermined lower level. When the received sector power is higher than −82 dBm, the gain can be set to low and remains unchanged even when a strong interference is detected. Furthermore, if the receiver is operable at a normal current mode and a current saving mode, the receiver is set to run at the normal mode when the received sector power is lower than −98 dBm, for example. When the received sector power is equal to or higher than −98 dBm, the receiver runs at the current saving mode unless a strong interference is present.

Thus, the first aspect of the present invention is an automatic gain control system for adjusting the gain of an RF front-end of a wireless communications device. The second aspect of the present invention is a method for controlling such gain. The third aspect of the present invention is a receiver in a wireless communication device having such an automatic gain control system. The automatic gain control system comprises:

an interferer level detector for determining an interference level;

a gain controller for setting the gain at a first gain level if the received sector power level is equal to or higher than a predetermined level, and setting the gain at a second gain level higher than the first gain level if the received sector power level is lower than the predetermined level, but when the interference level is higher than a predetermined interference value, reducing the gain to a third level lower than the second gain level.

The third level can be substantially equal to the first gain level, for example.

The system also comprises a current mode control module, responsive to the received sector power level, for setting the current level according to a higher current mode when the received sector power level is lower than a further level lower than the predetermined level, and setting the current level according to a lower current mode when the received sector power level is equal to or higher than the further level. When the received sector power level is equal to or higher than the further level and the interference level is greater than a predetermined interference value, the current level is increased to a higher level.

In a different embodiment of the present invention, the front-end can be set a high gain level, a mid gain level and a low gain level. The front-end is set at the high gain level when the receiver sector power level is lower than a first predetermined level, such as −85 dBm and the determined interference level is smaller than −35 dBm, for example. The front-end is set at the mid gain level when the receiver sector power level is lower than the first predetermined level and the determined interference level is greater than −35 dBm, for example. The front-end is also set at the mid gain level when the receiver sector power level is between the first predetermined level and a second predetermined level, such as −35 dBm and the determined interference level is smaller than −24 dBm, for example. Otherwise, the receiver is set to the low gain level.

The AGC system, according to the present invention, is able to maintain high receiver sensitivity in any possible condition as long as the interferers are not strong enough. Furthermore, because the receiver current is able to maintain at a current saving mode as long as the received sector power exceeds a predetermined level and the interferers are not strong enough. Thus, the AGC system also improves the receiver current consumption.

The present invention will become apparent upon reading the description taken in conjunction with FIGS. 1 to 5.

### BRIEF DESCRIPTION OF THE DRAWINGS

FIG. 1 is a block diagram of a receiver having an AGC system, according to the present invention.

FIG. 2 is shows the front-end gain and the receiver current control as plotted against the received sector power in the AGC, according to the present invention.

FIG. 3 is a state chart showing the receiver current mode and the front-end gain of an AGC system with two front-end gain modes, according to the present invention.

FIG. 4 is a state chart showing the receiver current mode and the front-end gain of an AGC system with three front-end gain modes, according to the present invention.

FIG. 5 is a schematic representation of a mobile terminal having a receiver, according to the present invention.

### DETAILED DESCRIPTION OF THE INVENTION

An RF receiver automatic gain control (AGC) system, according to the present invention, controls its front-end gain based on the presence of strong electromagnetic interference and the received sector power. When there is no presence of strong electromagnetic interference, the front-end gain of the receiver is set at a high level. As such, the receiver can be maintained at a high sensitivity level or a lower receiver noise figure in a broad dynamic range between 25 and 40 dB. Preferably, the receiver is operated at a current saving (CS) mode if such a mode is available. When a strong electromagnetic interference is detected, the gain is reduced. Preferably, the gain is switched to a predetermined lower gain level and the receiver is operated at a normal current mode, instead of the CS mode.

The receiver AGC system, according to the present invention, is explained in terms of a code-division multiple access (CDMA) receiver in a mobile terminal. However, the AGC system and its principle are applicable to other receivers as well. Furthermore, it is assumed that the receiver is at least operable at two current modes: a normal mode and a current saving (CS) mode. When the receiver is operated at the CS mode, it is assumed that the receiver has substantially the same sensitivity as when the receiver is operated in normal current consumption.

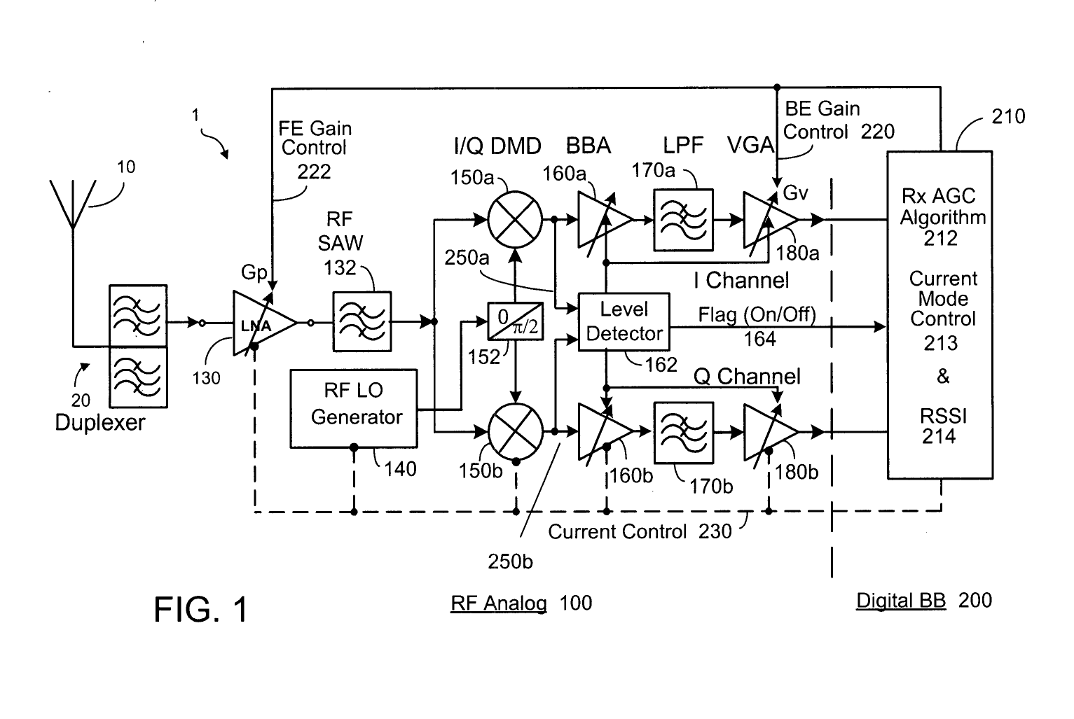

An exemplary CDMA mobile receiver, according to the present invention, is shown in FIG. 1. The receiver, as shown in FIG. 1, is a direct conversion receiver (DCR) with an interferer level detector (ILD). As shown, the receiver 1 comprises two sections: an RF analog section 100 and a digital base-band (BB) section 200. The RF analog section 100 comprises a duplexer 20 operatively connected to an antenna 10, and a low noise amplifier (LNA) 130 for receiving RF signals from the duplexer 20. After the received signals are filtered by a passband filter 132, they are frequency-down-converted by two quadrature mixers or demodulators 150a and 150b, which separately provides I and Q analog base-band signals 250a and 250b. As shown, an RF local oscillator (LO) generator 140 and a phase shifter 152 are used to provide the RF LO signals for down-conversion. The I and Q analog base-band signals are weakly coupled to an interferer level detector (ILD) 162 for electromagnetic interference detection. When the ILD 162 detects a strong interference exceeding −35 dBm, for example, it sets the flag 164 to ON. Otherwise the flag 164 is set to OFF.

The I and Q base-band signals are separately amplified by base-band amplifiers 160a, 160b; filtered by low-pass filters (LPFs) 170a, 170b; and amplified by variable gain amplifiers (VGAs) 180a, 180b in the I and Q channels. In the digital base-band section 200 of the AGC system of the present invention, only a control module 210 having a receiver AGC algorithm 212, a current mode control sub-module 213 and a received signal strength indicator (RSSI) 214 is shown. In order to adjust the front-end gain, a front-end gain control signal 222 is provided to the LNA 130. Likewise, a back-end gain control signal 220 is provided to the VGAs 180a, 180b. The gain control signals 220, 222 are provided based on the flag 164 from the ILD 162 and the received sector power as measured by the RSSI 214 in the digital base-band section 200. The control module 210 can also be used for controlling the current consumption in the RF analog section 100. For example, the control module 210 can provide a current mode control signal 230 to various components in the RF analog section 100, based on the received interference strength and the sector power, in order to operate the receiver RF front-end at a normal current mode or at a current saving (CS) mode.

The cases that the front-end gain, i.e., the LNA 130 stage gain of the receiver architecture as shown in FIG. 1 is adjustable only and the back-end gain is fixed, are discussed. It is assumed that the front-end gain change is the result of the LNA gain stepping up or down. For illustration purposes, the LNA has only tow gain modes, a high gain mode and a low gain mode. It is possible to achieve the LNA low gain mode by bypassing the LNA.

The receiver 1 can be operated as follows:
1. When the receiver is turned on or wakes up from the sleep mode, the LNA 130 is first operated at its high gain mode in order to maintain a high receiver sensitivity and the LNA is also operated at the normal current mode. The receiver stays at the high LNA gain mode if no strong interferer, such as that having an interference level of −35 dBm or higher, is detected by the ILD 162. In this situation, the flag 164 is set to OFF. Moreover, the receiver current keeps running at the normal mode as long as the received sector power as measured by the received signal strength indicator (RSSI) 214, for example, is lower than −98 dBm.
2. When the received sector power is equal to or higher than −98 dBm and there is no presence of a strong interferer (−35 dBm or higher), the LNA stays at the high gain mode and the current mode control signal 230 sets the receiver to a current saving (CS) mode.
3. If the received sector power is equal to or higher than −98 dB and a strong interferer (−35 dBm or higher) is detected, the receiver comes back to the normal current mode in response to the current mode control signal 230. At the same time, the front-end gain steps down to the low gain mode, in response to the front-end control signal 222, in order to achieve high linearity.
4. The gain at the LNA 130 stage is normally switched to the low gain mode when the received sector power is −82 dBm or higher even when there is no presence of a strong interferer. However, the current mode control signal 230 is set based on whether the flag 164 is ON or OFF. When the received sector power reaches −60 dBm or higher, for example, the receiver is always operated at the CS mode. Thus, when the received sector power is between −98 dBm and −60 dBm, the current mode is conditioned upon the presence of a strong interferer. In this received sector power range, the receiver is operated at the CS mode unless a strong interferer is detected.

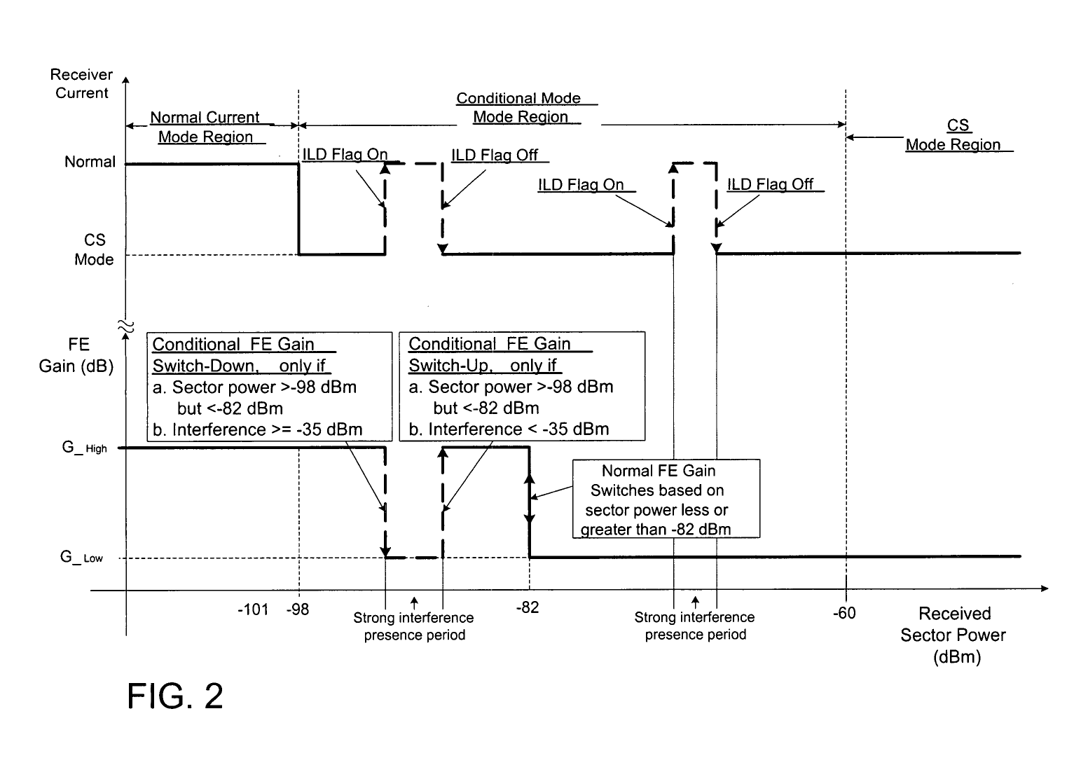

The front-end gain and the receiver current mode of the AGC system, according to present invention, are shown in the plot of FIG. 2. For illustration purposes, the plot only shows the direction of an increasing received sector power.
1. In the region of received sector power being lower than −98 dBm, the front-end gain is always high and the receiver is operated at the normal current mode.
2. In the region of received sector power between −98 dBm and −82 dBm, the front-end gain is high but the receiver is operated at a CS mode if no strong interference is detected.
3. In the same region, if a strong interferer is detected by the ILD and the flag 164 (see FIG. 1) is set to ON, the front-end gain turns to low and the receiver operates at the normal current mode.
4. After the strong interferer is gone and the flag 164 is set to OFF, the front-end gain resumes its high level and the receiver again operates at the CS mode.
5. When the received sector power is higher than −82 dBm, the front-end gain is switched to low regardless of the presence of strong interferers.
6. In the region of received sector power between −82 dBm and −60 dBm, the receiver is normally operated at the CS mode unless a strong interferer is detected. Thus, the receiver is operated at the normal current mode only when the flag 164 is ON.
7. When the receiver sector power is beyond −60 dBm, the receiver is always operated at the CS current mode regardless of the presence of strong interferers.

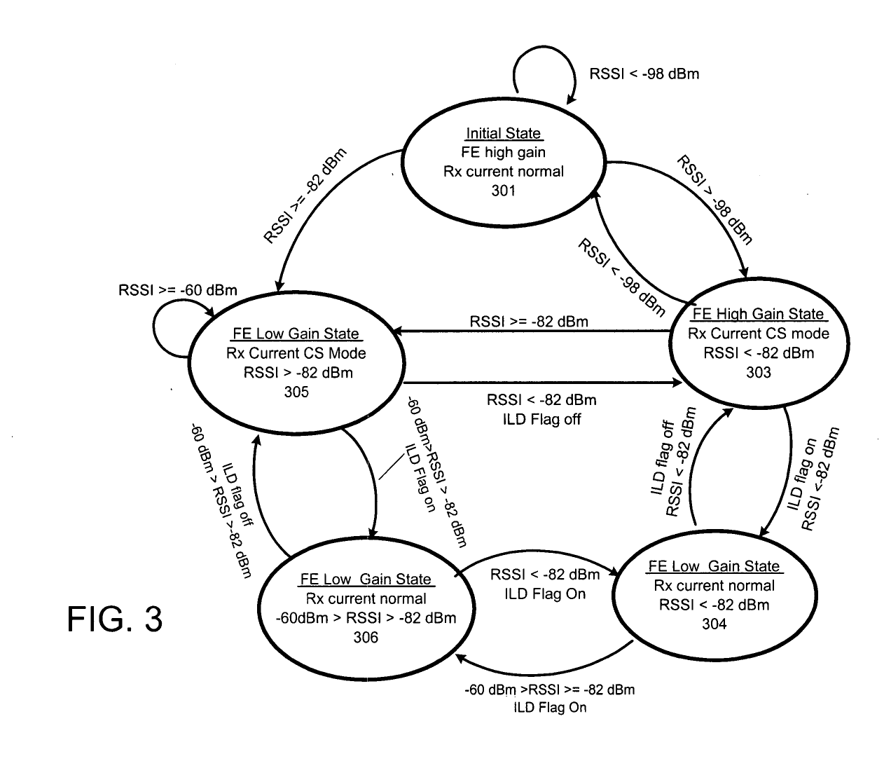

The state chart of the AGC system with only two front-end gain modes (high gain mode and low gain mode), according to the present invention, is depicted in FIG. 3. As shown in the state chart, there are five different operations states concerning the front-end gain and the receiver current mode.
Initially, the receiver is at the initial state 301 where the front-end gain is high and the receiver current mode is normal.
When the received sector power as measured by RSSI 214 is between −98 dBm and −82 dBm, the AGC is at state 303. At this state, the front-end gain is high and the receiver current is at the CS mode.
When the received sector power is lower than −82 dBm and the ILD flag is ON, the AGC is at state 304. At this state, the front-end gain is low and the receiver current mode is normal.
When the received power sector is between −82 dBm and −60 dBm, the AGC is at state 305. At this state, the front-end gain is low and the receiver current is at the CS mode.
Finally, when the received power sector is between −82 dBm and −60 dBm and the ILD flag is ON, the AGC is at state 306 where the front-end gain is low and the receiver current mode is normal.

To further improve the receiver performance, the LNA 130 (see FIG. 1) can be designed with three gain modes. As such, the LNA 130 also has a mid-gain mode between the high and low gain modes. With the mid-gain mode, the receiver sensitivity is better than that when it is operated at the low gain mode by bypassing the LNA 130. For example, the LNA can be designed to make a CDMA mobile receiver to have a −109 dBm sensitivity at the LNA high gain mode. At the mid-gain mode, the sensitivity of the receiver is about 5 to 6 dB lower than the high-gain mode. Thus, the receiver sensitivity is about −104 to −103 dBm. However, the linearity of the receiver is better at the mid-gain mode than at the high-gain mode.

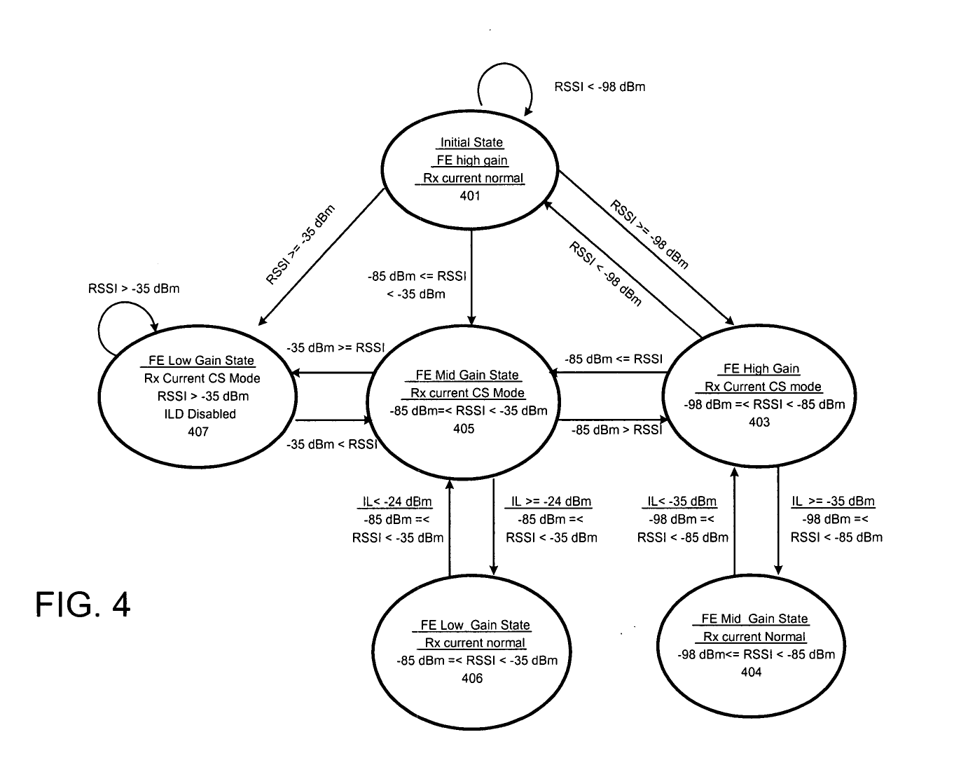

In order to improve the CDMA mobile receiver overall performance, it is preferable that the receiver operates at its mid-gain mode most of the time. A state chart illustrating the AGC system with three front-end gain modes (high, mid and low) is shown in FIG. 4.
When the receiver is turned on, the receiver is at its initial state (401) where the LNA is at the high gain mode and the receiver current is at the normal mode. The AGC stays with this state as long as the received sector power, RSSI, is lower than −98 dBm.
Depending upon the measured received sector power (RSSI 214) level, the state transits to a different state 403 or 407. As shown, if the received sector power is between −98 dBm and −82 dBm, the front-end gain is high but the receiver operates at the CS mode (state 403). If the received sector power is between −82 dBm and −35 dBm, the front-end gain is at the mid-gain mode and the receiver operates at the CS mode, with the ILD 162 (see FIG. 1) disabled (state 407).
If the AGC is at state 403 and the detected interferer level is equal to or higher than −35 dBm, then the AGC goes to state 404 from 403. The state will move back to 403 when the interferer level becomes lower than −35 dBm.
When the received sector power is equal to −85 dBm or higher, the AGC state transits to state 405 where the front-end gain is at the mid gain mode and the receiver operates at the CS mode. If the detected interferer level is equal to or greater than −24 dBm, the state progresses to state 406 where the front-end gain is low and the receiver current is normal. When the detected interferer level reduces to a level lower than −24 dBm, the state will move back to 405 from 406.
State (405) may transit to state 407 where the front-end gain is low and current is at the CS mode with ILD disabled, when the received sector power is equal to or greater than −35 dBm. The state will move back to 405 from 407 if the sector power RSSI <−35 dBm.
The AGC stays at state 407 as long as the received sector power is higher than −35 dBm.

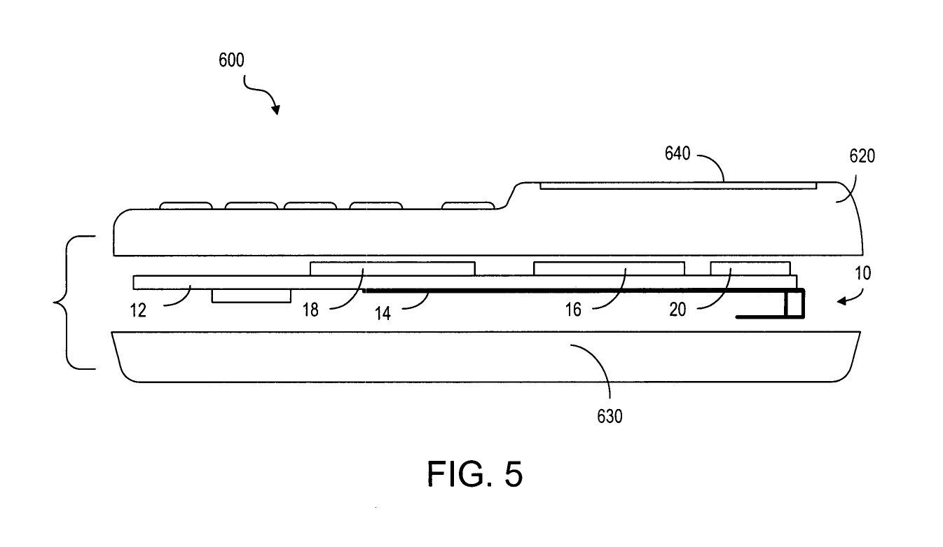

The AGC system with two or three LNA gain modes, according to the present invention, can be used in a CDMA mobile receiver as illustrated above. It should be noted that the same system can also be used in other receivers such as a time-division multiple access (TDMA) mobile receiver, a frequency-division multiple access (FDMA) system and the like. A mobile terminal having an AGC, according to the present invention, is illustrated in FIG. 5. As shown, the mobile terminal 600 comprises an upper housing part 620 and a lower housing part 630 to accommodate various mobile phone components. As shown, the mobile terminal 600 has a display 640 disposed on the upper housing part 620, and a circuit board 12 disposed between the upper and lower housing parts. The circuit board 12 has a ground plane 14 operatively connected to an antenna 10. The antenna 10 is operatively connected to a duplexer 20. The duplexer is operatively connected to a front-end module 16 and another signal processor 18. The front-end module 16 comprises a receiver 1 having the AGC system, according to the present invention. The AGC system may be operated at the two gain modes or at multiple gain modes.

In sum, the present invention provides an automatic gain control system and method for controlling the gain of an RF front-end of a wireless communications device, the communications device having a received signal strength indicator for providing a received sector power level. The system comprises an interferer level detector for determining an interference level, and a gain controller for setting the gain to low if the received sector power level is equal to or higher than a predetermined value, and setting the gain to high if the received sector power level is lower than the predetermined value. But when a strong interferer is present, the gain is reduced from high to low. As such, the AGC system, according to the present invention, is able to maintain high receiver sensitivity in any possible condition as long as the interferers are not strong enough. Furthermore, because the receiver current is able to maintain at a current saving mode as long as he received sector power exceeds a predetermined level and the interferers are not strong enough. Thus, the AGC system also improves the receiver current consumption.

It should be appreciated by persons skilled in the art that the numerical values of the received sector power and the detected interference level are for illustration purposes only. The received sector power and the detected interference level can be higher or lower.

Although a CDMA mobile station receiver has been used to illustrate the principle of the present invention, the system and method for automatic gain control, according to the present invention, can be used for the receivers in different protocol wireless systems. Thus, the triggered values regarding the received sector power and the detected interference level may change from one wireless system to another. These values may also vary depending on the receiver hardware designed.

Furthermore, the power saving features of the present invention have been illustrated by using two current modes: a normal mode and a current saving mode. However, it is possible to use three or more current modes for different received sector power levels and interference levels. It is also possible to adjust the current in a continuous fashion instead of an abrupt fashion.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method to adjust a gain in an RF front-end of a wireless communications device having a receiver for receiving communication signals, the received signals having a measured power level, wherein the communication signals are subject to an electromagnetic interference affecting the received signals, said method comprising the steps of:
detecting the interference for determining an interference level;
setting the gain at a first gain level if the measured power level is equal to or higher than a predetermined level; and
setting the gain at a second gain level higher than the first gain level if the measured power level is lower than the predetermined level, wherein when the measured power level is lower than the predetermined level and the determined interference level is higher than a predetermined interference value, reducing the gain to a third level lower than the second gain level.

2. The method of claim 1, wherein the third level is substantially equal to the first gain level.

3. The method of claim 1, wherein the receiver is operable at a first current mode and a second current mode, wherein the first current mode defines a higher receiver current level and the second current mode defines a lower received current level, said method further comprising the step of:
operating the receiver at the first current mode when the measured power level is lower than a further power level lower than the predetermined level.

4. The method of claim 3, further comprising the steps of:
operating the receiver at the second current mode when the measured power level is equal to or higher than the further power level; and
increasing the receiver current level to a level higher than the lower receiver current level, when the determined interference level is greater than a predetermined interference value.

5. The method of claim 4, wherein the increased receiver current level is substantially equal to the higher receiver current level.

6. The method of claim 3, further comprising the step of:
operating the receiver at the first current mode if the measured power level is equal to or higher than a predetermined level and the determined interference level is higher than the predetermined interference level.

7. The method of claim 2, further comprising the step of:
setting the gain at a fourth level higher than the second level if the measured power level is lower than the further power level, but if the determined interference level is greater than a further interference value, reducing the gain level to the second gain level.

8. The method of claim 7, wherein the receiver is operable at a first current mode and a second current mode, wherein the first current mode defines a higher receiver current level and the second current mode defines a lower receiver current level, said method further comprising the step of:
operating the receiver at the first current mode when the measured power level is lower than a third power level lower than the further power level.

9. The method of claim 8, further comprising the steps of:
operating the receiver at the second current mode when the measured power level is equal to or higher than the third power level; and
increasing the receiver current level to a level higher than the lower receiver current level, when the determined interference level is greater than a further interference value.

10. The method of claim 8, further comprising the steps of:
operating the receiver at the second current mode when the measured power level is equal to or higher than the further power level; and
increasing the receiver current level to a level higher than the lower receiver current level, when the determined interference level is greater than a predetermined value.

11. An automatic gain control system for adjusting a gain in an RF front-end of a wireless communications device, the wireless communications device having a receiver for receiving communication signals, the received signals having a measured power level, wherein the communication signals are subject to an electromagnetic interference affecting the received signals, said system comprising:
a gain controller for setting the gain at a first gain level if the measured power level is equal to or higher than a predetermined level; and setting the gain at a second gain level higher than the first gain level if the measured power level is lower than the predetermined level; and
an electromagnetic interference detector for determining an interference level, such that when the measured power level is lower than the predetermined level and the determined interference level is higher than a predetermined interference value, reducing the gain to a first level lower than the second gain level.

12. The automatic gain control system of claim 11, wherein the receiver is operable at a first current mode and a second current mode, wherein the first current mode defines a higher receiver current level and the second current mode defines a lower received current level, said control system further comprising:
a current mode control module, responsive to the measured power level, for setting the receiver current level according to the first current mode when the measured power level is lower than a further value lower than the predetermined value and setting the receiver current level according to the second current mode when the measured power level is equal to or higher than the further value.

13. The control system of claim 12, wherein the current mode control module sets the receiver current level according to the second current mode when the measured power level is equal to or higher than the further power level, but when the determined interference level is greater than a predetermined interference value, the receiver current is set according to the first current mode.

14. The control system of claim 12, wherein the gain controller sets the gain at a third level higher than the second level if the measured power level is lower than the further power level, but if the determined interference level is greater than a further interference value, reducing the gain level to the second gain level.

15. The control system of claim 14, wherein the receiver is operable at a first current mode and a second current mode, wherein the first current mode defines a higher receiver current level and the second current mode defines a lower receiver current level, said control system further comprising:
a current mode control module, responsive to the measured power level, for setting the receiver current level according to the first current mode when the measured power level is lower than a third power level lower than the further power level.

16. The control system of claim 15, wherein the current mode control module sets the receiver current level according to the second current mode when the measured power level is equal to or higher than the third power level, but when the determined interference level is greater than a further interference value, the receiver current level is set according to the first current mode.

17. The control system of claim 15, wherein when the measured power level is equal to or higher than the further power level, the receiver current level is set according to the second current mode, but when the determined interference level is greater than a predetermined value, the receiver current level is set according to the first current mode.

18. An RF receiver of a wireless communications device having an RF front-end for receiving communication signals, wherein the communication signals are subject to an electromagnetic interference affecting the received signals, said RF receiver comprising:
a frequency down converter module in the RF front-end, responsive to the received communication signals, for providing analog base-band signals;
means, responsive to the analog base-band signals, for measuring a signal power level;
a gain controller for setting a gain of RF front-end at a first gain level if the measured signal power level is equal to or higher than a predetermined, and setting the gain at a second gain level higher than the first gain level if the measured signal power level is lower than the predetermined level; and
an electromagnetic interference detector for determining an interference level, such that when the measured signal power level is lower than the predetermined level and the determined interference level is higher than a predetermined interference value, reducing the gain to a first level lower than the second gain level.

19. The receiver of claim 18, wherein the receiver is operable at a first current mode and a second current mode, wherein the first current mode defines a higher receiver current level and the second current mode defines a lower received current level, said receiver comprising:
a current mode control module, responsive to the measured signal power level, for setting the receiver current level according to the first current mode when the measured signal power level is lower than a further value lower than the predetermined value and setting the receiver current level according to the second current mode when the measured signal power level is equal to or higher than the further value.

20. The receiver of claim 19, wherein the current mode control module sets the receiver current level according to the second current mode when the measured signal power level is equal to or higher than the further power level, but when the determined interference level is greater than a predetermined interference value, the receiver current is set according to the first current mode.

21. The receiver of claim 19, wherein the gain controller sets the gain at a third level higher than the second level if the measured signal power level is lower than the further power level, but if the determined interference level is greater than a further interference value, reducing the gain level to the second gain level.

22. The receiver of claim 21, wherein the receiver is operable at a first current mode and a second current mode, wherein the first current mode defines a higher receiver current level and the second current mode defines a lower received current level, said receiver further comprising:
a current mode control module, responsive to the measured signal power level, for setting the receiver current level according to the first current mode when the measured signal power level is lower than a third power level lower than the further power level.

23. The receiver of claim 22, wherein the current mode control module sets the receiver current level according to the second current mode when the measured signal power level is equal to or higher than the third power level, but when the determined interference level is greater than a further interference value, the receiver current level is set according to the first current mode.

24. The receiver of claim 22, wherein when the measured signal power level is equal to or higher than the further power level, the receiver current level is set according to the second current mode, but when the determined interference level is greater than a predetermined value, the receiver current level is set according to the first current mode.
